(19) United States
(12) Patent Application Publication
(10) Pub. No.: US 2026/0194953 A1
(43) Pub. Date: Jul. 9, 2026

(54) POWER SYSTEM DEVICE AVAILABILITY DURING STARTUP AND POWER DISTURBANCES

(71) Applicant: Schweitzer Engineering Laboratories, Inc., Pullman, WA (US)

(72) Inventors: Donovan E. Wilkerson, Dothan, AL (US); Edmund A. Schweitzer, Pullman, WA (US); Alec Schmidt, Pullman, WA (US); Brian D. LaFerriere, Moscow, ID (US); Steven M. Frane, Pullman, WA (US)

(73) Assignee: Schweitzer Engineering Laboratories, Inc., Pullman, WA (US)

(21) Appl. No.: 19/441,332

(22) Filed: Jan. 6, 2026

Related U.S. Application Data
(60) Provisional application No. 63/742,556, filed on Jan. 7, 2025.

(51) Int. Cl. G06F 1/30; G06F 1/26

(52) U.S. Cl. CPC G06F 1/30; G06F 1/263; G06F 1/266

(57) ABSTRACT

The present disclosure relates to improving the monitoring of electric power systems. In one embodiment, a device consistent with the present disclosure may include an input for receiving information related to electric parameters at a location within the electric power system. A power supply in electrical communication with an external power source may provide conditioned electric power to components internal to the device. The power supply may include a power input in electrical communication with the external power source to receive electric power. A conditioning circuit may condition electric power from the external power source for use by the device. An energy storage device may store electric power from the external power source. An energy storage device control subsystem may draw power from the energy storage device upon loss of the external power source to enable the device to remain fully operational and to implement an action.

### RELATED APPLICATIONS

This application claims priority to U.S. Provisional Patent Application No. 63/742,556, titled POWER SYSTEM DEVICE AVAILABILITY DURING STARTUP AND POWER DISTURBANCES, filed on Jan. 7, 2025.

### TECHNICAL FIELD

This disclosure relates to maintaining the availability of power system devices during startup and power disturbances.

### BRIEF DESCRIPTION OF THE DRAWINGS

This disclosure includes illustrative embodiments that are non-limiting and non-exhaustive. Reference is made to certain of such illustrative embodiments that are depicted in the figures described below.

FIG. 1 illustrates a one-line diagram of an electric power delivery system and a plurality of monitoring and control devices consistent with embodiments of the present disclosure.

FIG. 2 illustrates a power system device comprising an energy storage device to provide extended ride-through during a power disturbance and consistent with embodiments of the present disclosure.

FIG. 3 illustrates a simplified block diagram of an IED capable of extended ride-through when external power is not available to the IED and consistent with embodiments of the present disclosure.

FIG. 4A illustrates a front cover of a power meter comprising a housing for an energy storage device consistent with embodiments of the present disclosure.

FIG. 4B illustrates a circuit board and a plurality of supercapacitors to be installed in the housing illustrated in FIG. 4A and consistent with the present disclosure.

FIG. 5 illustrates a simplified block diagram of an energy storage circuit consistent with embodiments of the present disclosure.

### DETAILED DESCRIPTION

Electric power systems may be monitored and protected using power system devices. Electric power system meters may be used at several locations to monitor electric power systems. Electric power meters may be used to monitor a variety of parameters related to electric power, such as, for example, energy, demand, power, current, voltage, frequency, load, waveform, flicker, voltage sag/swell/interruptions (VSSI), sequence of events, harmonics, and the like. Such data may be useful for revenue calculations, power quality analysis, protection settings, protective actions, system control, and/or historical data research.

Power system devices may be powered from a variety of sources. Many power system devices are deployed in substations, which provide electric power and often include backup power to keep them operational during a power interruption. Nevertheless, power system devices may experience brief or prolonged power outages. Even a brief disturbance in electric power to a device may be sufficient to cause the device to shut down and restart. During disturbances and startup, the power system device may be unable to provide its core protection and monitoring functions. What is needed is a power system device capable of maintaining functionality during an interruption of an external power source.

Disclosed herein are power system devices and related methods capable of riding through disturbances. Such systems and methods may offer enhanced monitoring during disturbances. Moreover, such systems may record data related to events that caused the interruption for post-event analysis.

The phrases “connected to” and “in communication with” refer to any form of interaction between two or more components, including mechanical, electrical, magnetic, and electromagnetic interaction. Two components may be connected, even though they are not in direct contact, via intermediary devices.

As used herein, the term “IED” may refer to any microprocessor-based device that monitors, controls, automates, and/or protects monitored equipment within a system. Such devices may include, for example, remote terminal units, differential relays, distance relays, directional relays, feeder relays, overcurrent relays, voltage regulator controls, voltage relays, breaker failure relays, generator relays, motor relays, automation controllers, bay controllers, meters, recloser controls, communications processors, computing platforms, programmable logic controllers (PLCs), programmable automation controllers, input and output modules, motor drives, and the like. IEDs may be connected to a network, and communication on the network may be facilitated by networking devices, including, but not limited to, multiplexers, routers, hubs, gateways, firewalls, and switches. Furthermore, networking and communication devices may be incorporated into an IED or communicate with an IED. The term “IED” may be used interchangeably to describe an individual IED or a system comprising multiple IEDs.

Some of the infrastructure that can be used with embodiments disclosed herein is already available, such as general-purpose computers, computer programming tools and techniques, digital storage media, and communications networks. A computer may include a processor, such as a microprocessor, microcontroller, logic circuitry, or the like. The processor may include a special-purpose processing device, such as an ASIC, PAL, PLA, PLD, Field-Programmable Gate Array, or other customized or programmable device. The computer may also include a computer-readable storage device, such as non-volatile memory, static RAM, dynamic RAM, ROM, CD-ROM, disk, magnetic media, optical media, flash memory, or other computer-readable storage medium.

Aspects of certain embodiments described herein may be implemented as software modules or components. As used herein, a software module or component may include any computer instruction or computer executable code located within or on a computer-readable storage medium. A software module may, for instance, comprise one or more physical or logical blocks of computer instructions, organized as a routine, program, object, component, data structure, etc., that perform one or more tasks or implement particular abstract data types.

A particular software module may comprise disparate instructions stored in different locations on a computer-readable storage medium, which together implement the described functionality of the module. Indeed, a module may comprise a single instruction or many instructions and may be distributed across several code segments, different programs, and several computer-readable storage media. Some embodiments may be practiced in a distributed computing environment in which tasks are performed by a remote processing device linked via a communications network. In a distributed computing environment, software modules may be located in local and/or remote computer-readable storage media. In addition, data tied or rendered together in a database record may be resident in the same computer-readable storage medium, or across several computer-readable storage media, and may be linked together in fields of a record in a database across a network.

Some of the embodiments of the disclosure can be understood by reference to the drawings, wherein like parts are generally designated by like numerals. The components of the disclosed embodiments, as typically described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments. Well-known structures, materials, or operations are not shown or described in detail to avoid obscuring aspects of this disclosure. In addition, the steps of a method do not necessarily need to be executed in any specific order, or even sequentially, nor need the steps be executed only once, unless otherwise specified.

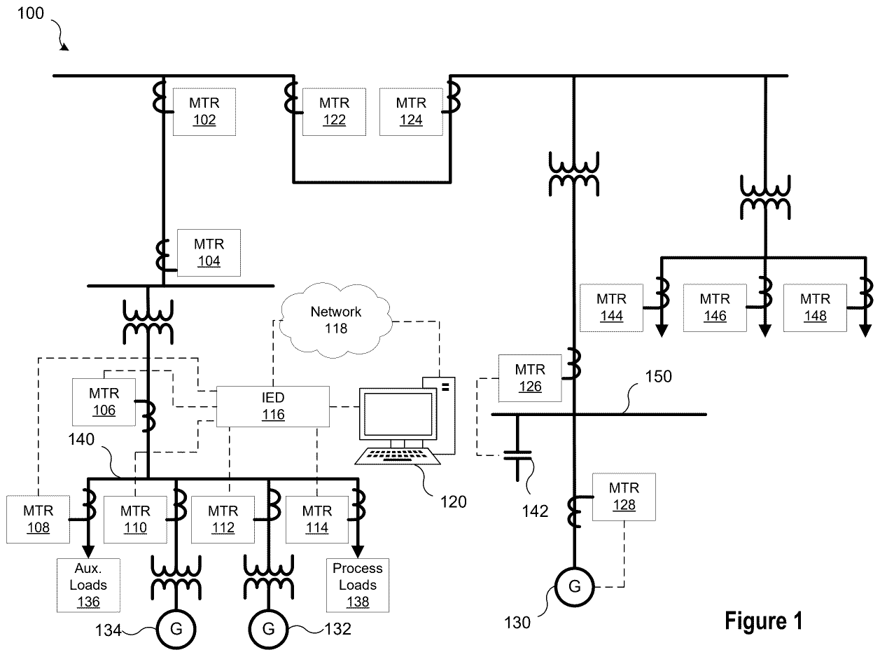

FIG. 1 illustrates a one-line diagram of an electric power system 100 and a plurality of monitoring and control devices consistent with embodiments of the present disclosure. Electric power system 100 includes several buses, feeders, generators, transformers, capacitors, loads, and the like. Also illustrated are several metering devices (MTR) throughout electric power system 100. In the illustrated embodiments, data connections are shown using dashed lines, and electric power system connections are shown using solid lines.

The metering devices in electric power system 100 have a variety of roles. For example, Meter 106 may monitor the net power output of the plant. Meter 102 may monitor line loading and phase angle measurement. Meter 104 may monitor various electric parameters, such as voltage and power quality. Although not specifically illustrated, meter 102 and meter 104 may be in communication with other devices in electric power system 100 either directly or via a communication network.

Meters 106-114 are part of a power plant, including generators 132, 134, which are in electrical communication with a bus 140. Power from generator 134 may be measured by meter 110, while power from generator 132 may be measured by meter 112. Meter 108 may measure power provided to auxiliary loads 136, while meter 114 may measure power provided to process loads 138.

Meters 106-114 may be in communication with an IED 116. IED 116 may implement various control or protection functions associated with the plant. IED 116 may further be in communication with a local monitoring and control system 120. IED 116 and local monitoring and control system 120 may be in communication with a network 118. In some embodiments, network 118 may allow remote access.

Meter 122 and meter 124 may monitor power exchange between two portions of electric power system 100. A power exchange between two portions of an electric power system may allow one operator to purchase or sell power depending on supply and demand. Meter 122 and meter 124 may monitor the inflow or outflow of electric energy for such purposes.

Meter 126 may be used in conjunction with the control of a capacitor bank 142. Capacitor bank 142 is in electrical communication with a bus 150. Capacitor bank 142 may provide reactive power support to counteract the effects of inductive loads such as transformers and motors.

A distributed generator 130 may be monitored by meter 128. Among other things, meter 128 may provide net billing to credit the owner of distributed generator 130 for electricity supplied to electric power system 100. In some embodiments, meter 128 may also provide control of distributed generator 130.

Meter 144, meter 146, and meter 148 may each be associated with a respective feeder. The feeders may provide power to a specific region or area served by electric power system 100. Meters 144-148 may provide information about energy consumption and load management. In addition, meters 144-148 may help to enable load management and diagnostics.

Electric power system 100 may provide electric power to the devices (e.g., meters, IED, etc.) that monitor and control it. The availability of digital protection and control devices helps to ensure a safe and reliable control system. As such, maximizing the availability of such devices can improve electric power system 100.

Some power interruptions are brief, such as those caused by a transient fault; however, a power interruption lasting only a few milliseconds can disable a protection relay for several seconds as it goes through a bootup cycle. In addition, the downtime due to an automatic diagnostic restart is exacerbated the longer the device takes to reboot.

A variety of conditions and events can disable a monitoring or protection device. Such conditions and events include transitory short circuits on a DC control power circuit, fuse or breaker operation on either a DC or AC circuit; control power transfer from a DC source to an AC backup; a voltage drop on a DC power circuit when a trip coil energizes; an undersized or failing DC power supply in response to increased load; AC faults upstream or downstream from the control device; and intermittent ac system availability.

Availability becomes more important the closer the device is to the asset. For example, a transformer protection relay would ideally boot up instantaneously and ride-through a sustained voltage interruption, while a centralized software server may take seconds or minutes to boot up and still meet the end-user's requirements.

During a power disturbance, the devices illustrated in FIG. 1 should ideally continue to perform their core function, record the event, and conduct an orderly shutdown if the disturbance exceeds a specified duration. Otherwise, for short disturbances (e.g., a few milliseconds to a few tens of milliseconds), a power system device will not have time to clear a fault. For longer disturbances (i.e., a few tens of milliseconds up to 1,000 milliseconds), a monitoring device may fail to save information about the event that caused the disruption.

IEC standards may allow undervoltage ride-through of just 20 milliseconds; however, this short ride-through capability may be insufficient in some applications. For example, even if the relay stays energized long enough to trip a breaker to clear a fault, it may lose power and fail to record an event report, SER records, or store latching logic. Such information can be useful in post-event analysis and other applications. One option for addressing these issues is to incorporate an uninterruptible power supply (UPS); however, this option adds both initial and ongoing maintenance costs. UPS solutions typically rely on batteries; however, batteries have a relatively short lifespan (e.g., a few years) and may not be suited for the large temperature range (e.g., −40° C. to +85° C.) that electric power system infrastructure is expected to support.

DC sources can have issues as well. For example, a short on a DC bus could cause a voltage drop prior to the fuse clearing that lasts longer than the connected equipment's ride-through capabilities. DC control power can become intermittent due to battery failures, DC control system faults, breaker solenoid inrush, battery charger failures, and failure to maintain batteries.

Embodiments consistent with the present disclosure comprise an energy storage device that stores electric power from a power source and provides electric power to components internal to the device upon loss of the power source. Energy storage devices of various types and sizes are contemplated. In one example, an energy storage device may provide sufficient power for a device to operate for a time between about one second and a few seconds. Upon loss of the primary power source, the device may implement protective actions, store information, and complete an orderly shutdown.

In another example, an energy storage device may provide sufficient power to ride-through a transition from a primary source to a backup power source. Backup power sources may be available in as little as 250 milliseconds, and as such, an energy storage device in this example may store less energy than in the previous example. In various embodiments, an energy storage device may be sized to provide sufficient electric power to keep the device fully functional until a backup power source is activated. For example, a specific implementation may include a backup generator that takes between 5 and 10 seconds to start. In such a situation, the energy storage device may be sized to cover the startup period along with a margin to account for any variations, unexpected circumstances, or margins (e.g., 20 seconds, 30 seconds, etc.).

Still further, some embodiments may comprise energy storage devices sized according to criteria related to the system in which the devices operate. For example, the fault clearing time may be used to determine an appropriate ride-through time. For example, various embodiments may include energy storage devices that provide sufficient power to ride through a disturbance that is between 1.5 and 2 times the maximum fault clearing time, including circuit breaker operation time.

In some embodiments, a device comprising an energy storage device may enable all functions of the device for a ride-through period. Such embodiments may simply draw power from the energy storage device rather than an external power source. Such embodiments may enable the full functionality of the device. Other embodiments may enable a subset of features or components. Such embodiments may be able to offer additional ride-through time for a given amount of stored energy by reducing power consumption of the device during the ride-through period.

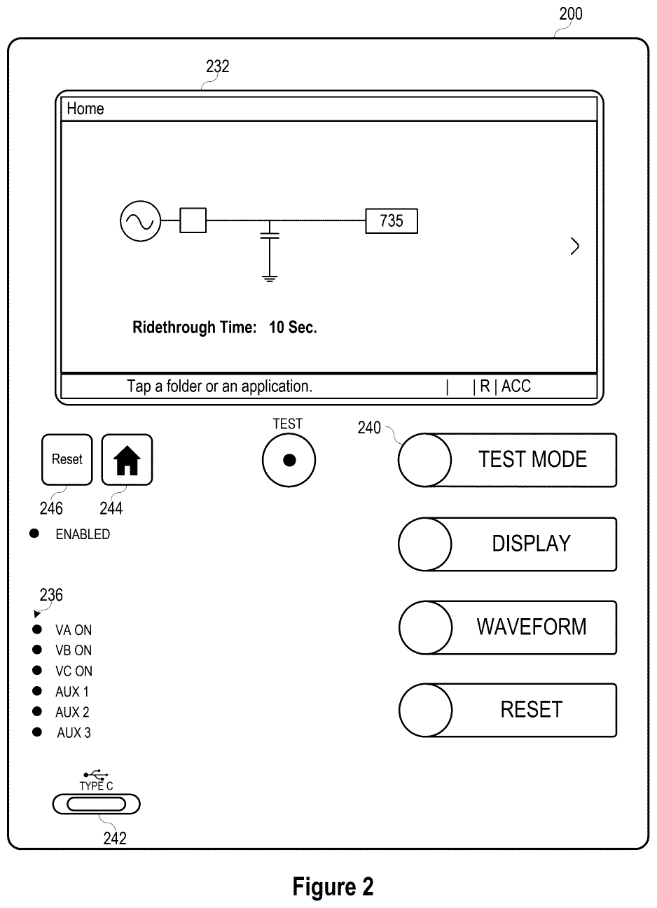

FIG. 2 illustrates a power system device 200 comprising an energy storage device to provide extended ride-through during a power disturbance and consistent with embodiments of the present disclosure. The illustrated power system device 200 is a meter that includes a display 232. The power system device 200 also includes various status LEDs 236, pushbuttons 246, 244, 240, and communication ports 242. As shown on display 232, the power system device 200 includes an indication of the time it has been providing self-power during a disturbance to the control power being supplied to the power system device 200. As shown on display 232, the device has been operating for 10 seconds without external power.

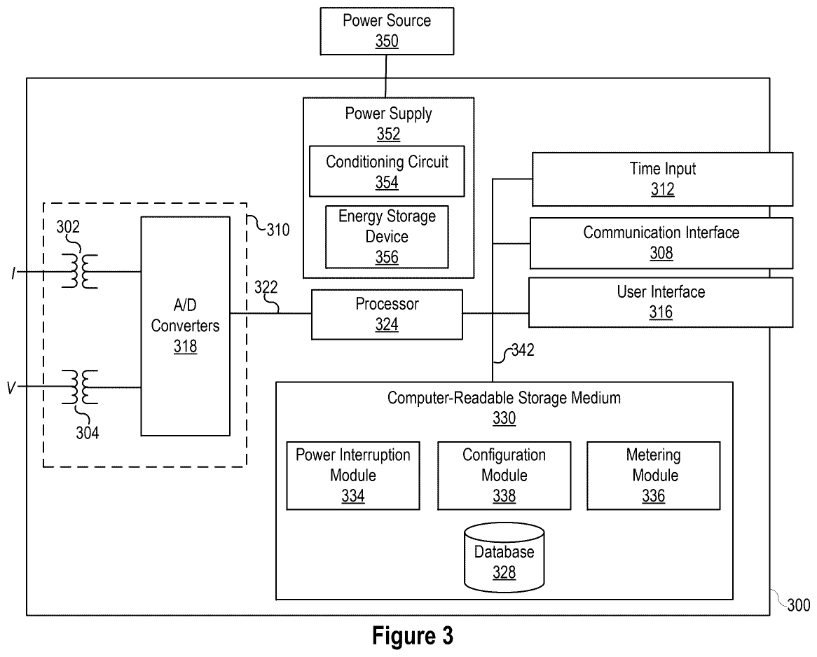

FIG. 3 illustrates a simplified block diagram of an IED capable of extended ride-through when external power is not available to the IED and consistent with embodiments of the present disclosure. The IED 300 includes a sensor component 310 for receiving signals from the monitored equipment. As illustrated, the sensor component 310 is configured to receive current and voltage signals from the monitored equipment. In other embodiments, other electric parameters may also be monitored. Other information may be obtained from various inputs, such as open/closed status, frequency, temperature, level, composition, and the like. As illustrated, the input includes transformers 302 and 304 for stepping the obtained voltage and current signals to an acceptable level for use by an analog-to-digital (A/D) converter 318. The A/D converter 318 may sample and digitize the signals from transformers 302, 304 to provide digitized analog signals 322 to the processor 324.

Data bus 342 may be in communication with, and facilitate data transfer among the processor 324, computer-readable storage medium 330, time input 312, communication interface 308, user interface 316, and others. Data bus 342 may include one or more data buses not separately illustrated.

Communication interface 308 may facilitate communication of information with other devices. The communication may include transmission and reception of power system data (e.g., measurements obtained by sensor component 310). A user may use the user interface 316 to provide configuration inputs to the IED 300.

Computer-readable storage medium 330 may be a repository of computer instructions that, when executed by the processor 324, cause the IED 300 to perform various functions described herein. For example, a metering module 336 may be included to perform metering functions. Although the different modules are illustrated as separate modules, the functions may be provided in the same or different blocks of instructions, stored on the same or different media.

Computer-readable storage medium 330 may also store information, including information related to or gathered by IED 300. A database 328 may store various types of information, such as the configuration provided by the user via the user interface 316, measurements made by sensor component 310, event reports, etc.

IED 300 includes a power supply 352 that receives electric power from a power source 350 and provides electric power at appropriate levels to various components of the IED 300. A power supply will typically receive 12-250 Vdc and 40-300 Vac, which it converts to internal voltages of around 0.6 to 15 Vdc to supply the onboard electronics. A conditioning circuit 354 may receive energy from power supply 352 and may condition the energy for use by the components of IED 300. Conditioning circuit 354 may regulate voltage, filter noise, and/or smooth fluctuations in power received from power supply 352. Among other things, conditioning circuit 354 may condition energy for storage by energy storage device 356.

A typical power supply has bulk capacitance that allows continued power output when power input is lost; however, the energy is rapidly consumed. A power supply with a low bulk capacitance may exhaust this energy in about 50 milliseconds, while a power supply with a large bulk capacitance may exhaust the energy in about 200 milliseconds. If a power interruption lasts longer than the energy stored by the bulk capacitance, the device will power off. A loss of power may cause loss of communication, loss of data capture, shutdown in an indeterminate state, and may prevent writing information about a fault to non-volatile memory. In addition, IED 300 may not be able to control or measure inrush upon power restoration, and may result in a power-up delay once the system re-energizes.

In accordance with several embodiments herein, the power supply 352 may include an energy storage device 356 capable of storing sufficient energy to provide electric power to IED 300 during the unavailability of the power source 350. In various embodiments, the energy storage device may have sufficient capacity to provide electric power to IED 300 for at least 10 seconds of operation. The energy storage device 356 may be capable of starting to provide electric power to the IED 300 upon loss of the power source 350. The transition time between the loss of the power source 350 and the initiation of the energy storage device 356 may be less than a de-energization time that would cause the IED 300 to restart.

In various embodiments, the energy storage device 356 may be a supercapacitor. A supercapacitor management circuit may be included to provide equal ride-through regardless of primary power supply input voltage from low line to high line. Supercapacitors offer several advantages, including a high energy density. The high energy density may allow for the incorporation of an energy storage device within IED 300. In some embodiments, supercapacitors may offer as much as 20 times the energy density of batteries commonly used in UPS devices. In addition, supercapacitors have a longer lifespan and a larger operating temperature range than batteries.

A power interruption module 334 may implement a variety of actions in response to an interruption in power supplied by power source 350. For example, power interruption module 334 may continue to perform its core function, record the event, and conduct an orderly shutdown. In another embodiment, power interruption module 334 may implement a transition to a backup power source. More specifically, following a power interruption, power interruption module 334 may signal the generator to start, monitor the generator performance, and close a transfer switch when the generator is ready to provide backup power.

Of course, an IED with enhanced ride-through capabilities may be used in a wide variety of applications and offer several advantages. For example, such an IED may be used to monitor signals before, during, and after a sustained power disruption. An IED may be used to signal a loss of power across a network. The IED may be used to enable an orderly shutdown routine, write an event report to flash, store the last energy measurement, write to a log, and the like. The IED may be used to measure the connected PT/CT circuits when no power is applied, to detect low-level residual voltage. The IED may be used to monitor inrush during power restoration. The IED may be used to control other devices after the power supply input has ceased (e.g., circuit breaker control). The IED may be used for self-diagnostics. If an internal power supply failure, such as a blown fuse or an MOV open circuit, occurs, the IED can identify the failure and write the power system diagnostics to memory. The IED may be used to stream raw sampled data after loss of power to an accumulator, including mega-sample-per-second data and energy packets. The IED may be used to monitor other IEDs and assets, such as circuit breakers, at the same location to ensure they operate correctly during and after the power disturbance. The IED may be used to reduce or eliminate the need for external backup energy sources.

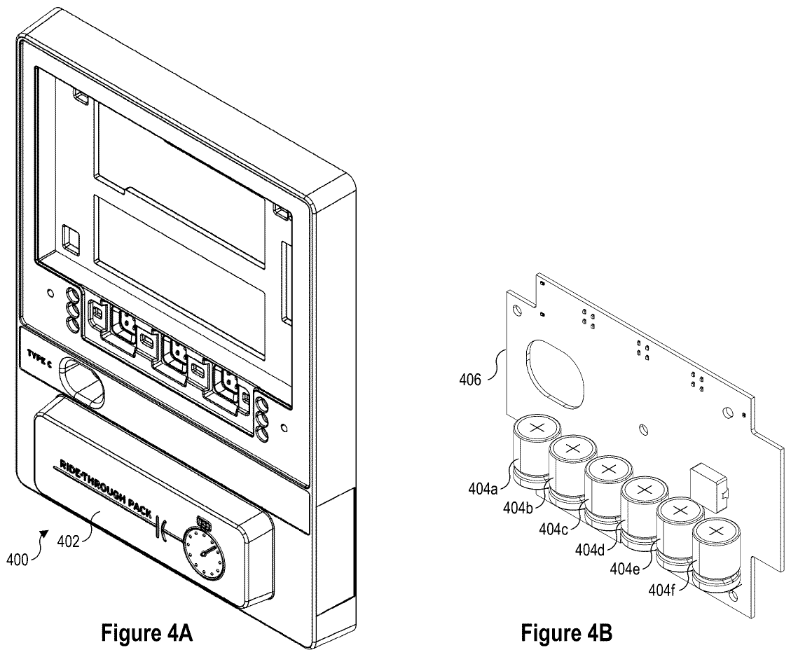

FIG. 4A illustrates a front cover of a power meter 400 comprising a housing 402 for an energy storage device consistent with embodiments of the present disclosure. In the illustrated embodiment, housing 402 is disposed outward from the front cover of power meter 400. Positioning the housing substantially outside the chassis of power meter 400 may provide a lower average temperature than the interior of power meter 400.

IEDs, such as power meter 400, may operate in areas without climate control. Moreover, an IED, such as power meter 400, generates heat while in operation. As such, the temperature inside the chassis of power meter 400 may exceed the ambient temperature. Although supercapacitors are more resistant to extreme temperatures than other energy storage devices (e.g., batteries), high temperatures can impact their operational life. As such, reducing the average temperature may provide added longevity.

FIG. 4B illustrates a circuit board 406 comprising a plurality of supercapacitors 404a-404f to be installed in the housing illustrated in FIG. 4A and consistent with the present disclosure. The plurality of supercapacitors 404a-404f may be afforded some separation from the chassis of power meter 400 and the elevated temperatures in the chassis.

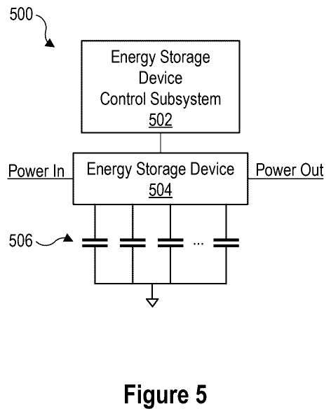

FIG. 5 illustrates a simplified block diagram of an energy storage system 500 consistent with embodiments of the present disclosure. The energy storage system receives input power from an external power source (not shown) and may provide power to a device (not shown) when the external power source is unavailable. Power from the external power source may be stored by energy storage device 504. In the illustrated embodiment, energy storage device 504 is in electrical communication with a plurality of capacitors 506. In some embodiments, the plurality of capacitors 506 may comprise supercapacitors. In one specific embodiment, the plurality of capacitors 506 may comprise electrochemical double-layer capacitors (ELDC). The energy storage circuit may include a control and a charge trap.

An energy storage device control subsystem 502 may be in communication with and control the operation of energy storage device 504. In various embodiments, energy storage device control subsystem 502 may be implemented using hardware or software. Energy storage device control subsystem 502 may maintain energy storage device 504 in a charged state while input power is available. The plurality of capacitors may have a self-discharge rate. As such, energy storage device control subsystem 502 may monitor the energy stored by the plurality of capacitors 506 and add additional energy to replace energy lost due to self-discharge or other factors.

When external power is unavailable, energy storage device control subsystem 502 may cause energy storage device 504 to provide power to a device (not shown). Upon the loss of the external power source, energy storage device control subsystem 502 may communicate the loss of external power to other components to initiate appropriate action (e.g., recording data about the outage and saving the data to non-volatile l memory, implementing an orderly shutdown of the device, etc.).

The examples and illustrations provided relate to specific embodiments and implementations of a few of the many possible variations. It is understood that the disclosure is not limited to the precise configurations and components disclosed herein. Accordingly, many changes may be made to the details of the above-described embodiments without departing from the underlying principles of this disclosure. The scope of the present invention should, therefore, be determined in the context of the possible claims that are supportable by this disclosure, including the following:

What is claimed:

1. A device for monitoring an electric power system, comprising:
an input for receiving information related to electric parameters at a location within the electric power system;
a power supply in electric communication with an external power source to provide conditioned electric power to components internal to the device, the power supply comprising:
a power input in electrical communication with the external power source to receive electric power;
a conditioning circuit in electrical communication with the power input to condition electric power from the external power source for use by the device; and
an energy storage device in electrical communication with the conditioning circuit to store electric power from the external power source; and
an energy storage device control subsystem to:
draw power from the energy storage device upon loss of the external power source to enable operation of the device, and
implement an action in response to the loss of the external power source.

2. The device of claim 1, wherein the device comprises an electric power monitor.

3. The device of claim 1, wherein the energy storage device stores electric power sufficient to enable all functions of the device for a ride-through period.

4. The device of claim 3, wherein the ride-through period comprises between about 1 second and about 20 seconds.

5. The device of claim 1, wherein the energy storage device comprises a housing for the energy storage device disposed substantially outside the device.

6. The device of claim 5, wherein the housing for the energy storage device provides a lower average temperature compared to an interior of the device.

7. The device of claim 1, wherein the energy storage device comprises a plurality of supercapacitors.

8. The device of claim 1, wherein the action comprises signaling a backup generator to start, monitoring the backup generator, and closing a transfer switch when the backup generator is ready to provide power.

9. The device of claim 8, wherein the energy storage device stores electric power sufficient to power the device until a backup power source is activated.

10. The device of claim 1, wherein the action comprises saving information related to the loss of power in non-volatile memory and implementing an orderly shutdown of the device.

11. A method of monitoring an electric power system using a device, the method comprising:
receiving information related to electric parameters at a location within the electric power system using the device;
receiving electric power from an external power source using a power input of a power supply of the device;
conditioning the electric power for use by the device using a conditioning circuit in electrical communication with the power input of the power supply;
storing electric power from the external power source using an energy storage device in electrical communication with the conditioning circuit;
drawing power from the energy storage device upon loss of the external power source to enable operation of the device using an energy storage device control subsystem; and
implementing an action in response to the loss of the external power source using the energy storage device control subsystem.

12. The method of claim 11, wherein the device comprises an electric power monitor.

13. The method of claim 11, wherein the energy storage device stores electric power sufficient to enable all functions of the device for a ride-through period.

14. The method of claim 13, wherein the ride-through period comprises between about 1 second and about 20 seconds.

15. The method of claim 11, further comprising providing a housing for the energy storage device disposed substantially outside the device.

16. The method of claim 15, wherein the housing for the energy storage device provides a lower average temperature compared to an interior of the device.

17. The method of claim 11, wherein the energy storage device comprises a plurality of supercapacitors.

18. The method of claim 11, wherein the action comprises signaling a backup generator to start, monitoring the backup generator, and closing a transfer switch when the backup generator is ready to provide power.

19. The method of claim 18, further comprising storing electric power using the energy storage device sufficient to power the device until a backup power source is activated.

20. The method of claim 11, wherein the action comprises saving information related to the loss of power in non-volatile memory and implementing an orderly shutdown of the device.
